(19) United States
(12) Patent Application Publication
(10) Pub. No.: US 2012/0015071 A1
(43) Pub. Date: Jan. 19, 2012

(54) COATED CONFECTIONERY AND CHEWING GUM COMPOSITIONS AND METHODS FOR MAKING THEM

(76) Inventors: Omar Ortega, San Pedro Cholula (MX); Denise Carvalho Pereira de Souza, Bauru (BR); Carlos Mitsuo Shimokomaki, Sao Paulo (BR); Hector Gil-Garza, Puebla (MX)

(21) Appl. No.: 13/148,671

(22) PCT Filed: Feb. 9, 2010
(86) PCT No.: PCT/IB10/00376

§ 371 Date: Sep. 30, 2011

Related U.S. Application Data
(60) Provisional application No. 61/151,217, filed on Feb. 10, 2009.

(51) Int. Cl. A23G 3/54; A23G 3/42; A23G 4/20

(52) U.S. Cl. 426/5; 426/103; 426/293

(57) ABSTRACT

The present invention is directed generally to coating compositions and products containing the same. More particularly, the present invention relates to confectionery compositions that include coating compositions which are in particulate form, and binders that have sufficient viscosity and tackifying agent levels so as to effectively bind the particulate coating compositions.

### FIELD

The present invention is directed generally to coating compositions and products containing the same. More particularly, the present invention relates to confectionery compositions that include coating compositions which are in particulate form, and binders that have sufficient viscosity and tackifying agent levels so as to effectively bind the particulate coating compositions.

### BACKGROUND

Coatings may be added to confectionery and chewing gum compositions in order to provide additional colors, flavors, and textures. One type of coating includes at least partially covering the outer surface of confectionery and chewing gum compositions with a coating that is in particulate form.

Traditionally, confectionery and chewing gum compositions have not sufficiently been capable of adhering larger-size particulates such as nonpareils to their outer surfaces without exposing the confectionery to extreme conditions, such as exposure to steam in order to create a tacky surface. Another problem with traditional coated confectionery pieces is that coating compositions, especially those which include a plurality of heavier and larger particle sizes than other coating compositions tend not to fully bind the large coating particles. In order to sufficiently bind larger-size particulates such as nonpareils to the outer surface, a suitable binder should be applied to the outer surface of these confectionery and chewing gum compositions, which has a proper viscosity and adhesion profile. However, traditionally, such binders tend to be expensive, therefore making their use impractical.

There is a need, therefore, for confectionery and chewing gum compositions and products processes including the same, which provide the ability to suitably bind and hold coating compositions including larger-scale particles to the outer surface thereof and which solve the problems of the prior coating processes.

### SUMMARY

In one aspect of the present invention, there is provided a confectionery composition including: a first region having at least one outer surface; a second region at least partially surrounding the outer surface, where the second region includes a binder; and a third region including a plurality of larger-size particulate candy pieces bound to the second region; where the second region has a sufficient amount of a tackifying agent to bind the larger-size particulate candy pieces to the first region.

In another aspect, there is provided a process for forming a coated confectionery composition including the steps of: forming a confectionery region having at least one outer surface; applying a binder to the outer surface; and applying a plurality of larger-size particulate candy pieces to bind to the binder; where the binder has a sufficient amount of a tackying agent to bind the larger-size particulate candy pieces to the confectionery region.

In yet another aspect of the invention, there is provided a confectionery composition including: a first region having at least one outer surface; a second region at least partially surrounding the outer surface, the second region including a binder solution including: about 30% to about 50% sugar; about 20% to about 40% water; about 5% to about 15% glucose; about 5% to about 30% dextrin; and about 8% gum arabic; and a third region including a plurality of nonpareils bound to the second region; where the second region has a sufficient adhesion value to bind the nonpareils to the confectionery region.

### DETAILED DESCRIPTION

The term “larger-size particulate candy pieces” or “larger-size” particulates refers to particulate candy pieces that are larger than typical sanding or dusting particles. Typical “larger-size particles” include nonpareils and flakes. Other typical larger-size particulate candy pieces include such materials as wheat-based fruit flakes, lyophilized fruit flakes, hard candy particles, and combinations thereof. In some embodiments, an individual larger-size particle used herein may have a particle size of about 0.1 to about 10 mm in diameter. The individual larger-size particle may be any size desired, and may have a diameter of at least 0.1 mm, at least 0.5 mm, at least 1 mm, at least 2 mm, at least 3 mm, and at least 4 mm.

As used herein, the term “nonpareil” may refer to any small, particulate candy form. The term “nonpareil” may include particulate candy pieces that are small enough to form a coating of a traditional confectionery or chewing gum piece, but are larger and heavier than traditional sanding or dusting compositions. Nonpareils can be produced by any process known in the art, such as those including the steps of: building up a core, such as a sugar crystal or a compressed tablet; increasing volume by adding saturated sugar syrup to a rotating pan; evaporating excess water from the bulked-up core to form a hard sugar crystal shell; repeating the above steps until a desired target size and weight is achieved; and flavoring the nonpareil. In some embodiments, the nonpareils are between four to six millimeters in diameter. Nonpareils may be made by other process such as binding sugars, colorants and flavorants with a binder, such as gum, and forming the bound constituents by any one of the steps of stamping, tabletting or die forming, and drying the formed sugar to produce nonpareils of a desired hardness and size. Typically, nonpareils have a spherical shape, but may be in other shapes such as stars, crescents, animals, snowflakes, rocks, pebbles, hearts, and the like. Nonpareils may include sugared or sugarless candy forms, and may include one or more colors, flavors, or other desired additives. Suitable nonpareils for use in the present invention include those described in U.S. Pat. No. 6,797,294, the entire contents of which are incorporated by reference herein.

The term “confection”, or “confectionery” or “confectionery base” may include any conventional confectionary composition, such as gummy candy or “gummi” confections (gummy candy includes a hydrocolloid texturizing agent such as gelatin alone or in combination with other texturizing agents). Also included in those chewable forms are soft candies such as, but not limited to, gum drops, licorice, fruit snacks, starch based jellies, gelatin based jellies, pectin based jellies, carageenan based jellies, agar based jellies, konjac based jellies, chewy candy, starch candy, nougat, toffee, taffy, marshmallow, fondant, fudge, chocolate, compound coating, carob coating, caramel, compressed tablets, candy floss (also known as cotton candy), marzipan, hard boiled candy, nut brittles, pastilles, pralines, dragees, lozenges, sugared nuts, comfits, aniseed balls, nougatine, and jelly beans. Also included in those chewable forms are chewing gums including bubble gums. The basis of gummy confections is generally a sugar/glucose syrup or a polyol/polyol syrup or sugar/polyol combination and a gelatinizing agent, the latter of which may be gelatin, agar, gum arabic, maltodextrin, pectin, carageenan, konjac, modified starches or combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

As used herein, the term “gum region” or “confectionery region” refers to a region of a multi-regioned confectionery product, and may include center-fill gum or confectionery products, respectively, that may be adjacent to or at least partially surrounding the center-fill, or innermost, region. In some embodiments, the gum region or confectionery region is an intermediate region or an interior region.

As used herein, the term “center-fill” refers to the innermost region of a center-fill gum or confectionery product. The term “center-fill” does not necessarily imply symmetry of a gum or confectionery product, only that the “center-fill” is within another region of the product. In some embodiments, the center-fill may be substantially symmetric and in others, the center-fill may not be symmetric of the chewing gum or confectionery piece. In some embodiments, more than one center-fill may be present. A center-fill may include solid, liquid, gas and mixtures thereof. The term “liquid” in the context of a center-fill includes fluid materials as well as semi-solid or gel materials. The center-fill can be aqueous, non-aqueous, or an emulsion.

As used herein, the terms “coating” or “coating region” are used to refer to the outermost region of a chewing gum or confectionery product. In preferred embodiments, the coating or coating region includes a plurality of larger-size particulate pieces, such as nonpareils, but may include any other additional coating materials desired. In some embodiments, the coating may be amorphous or crystalline and it may be continuous or particulate. Confections or chewing gum compositions that including the coating region are referred to generally as “coated”.

As used herein, the terms “surround,” “surrounding,” and the like are not limited to encircling. These terms may refer to enclosing or confining on all sides, encircling or enveloping, and are not limited to symmetrical or identical thicknesses for a region in a center-fill gum or confectionery product.

The transitional term “comprising” (also “comprises,” etc.) which is synonymous with “including,” “containing,” or “characterized by,” is inclusive or open-ended and does not exclude additional, unrecited elements or method steps, regardless of its use in the preamble or the body of a claim.

In some embodiments, one or more materials may be encapsulated. Encapsulating material for encapsulating the encapsulated ingredient includes any one or more water soluble or water insoluble polymers, co-polymers, or other materials capable of forming a coating, shell, or film as a protective barrier or layer around one or more ingredients and/or capable of forming a matrix with the one or more ingredients. In some embodiments, the encapsulating material may completely surround, coat, cover, or enclose an ingredient. In other embodiments, the encapsulating material may only partially surround, coat, cover, or enclose an ingredient.

### Coating Composition

The confectionery compositions described herein may include one or more coating compositions at least partially surrounding one or more layers of the composition. Coating compositions may include any conventional ingredient such as, but not limited to, sweeteners, flavors, sensates, functional ingredients, and food acids. In some embodiments, the coating composition may be in particulate form, crystalline form, or amorphous form. As will be described in more detail below, the coating may be in the form of a plurality of larger-size particulate candy pieces such as nonpareils, hard candy particles, flakes, and the like. In some embodiments, the coating composition may be continuous or discontinuous. If desired, the coating may completely surround, coat, cover, or enclose a confectionery base. Alternatively, the coating may only partially surround, coat, cover, or enclose a confectionery base.

The selection of the form of the coating composition may depend on the desired texture of the confectionery composition.

In some embodiments, the coating composition may include one or more sweeteners, and/or one or more flavors, and/or one or more sensates, and/or one or more salts, and/or one or more functional ingredients, and/or one or more food acids. In some embodiments, the one or more sweeteners, and/or one or more flavors, and/or one or more sensates, and/or one or more functional ingredients, and/or one or more food acids may be encapsulated, unencapsulated (or “free”) or a combination of encapsulated and unencapsulated.

In embodiments where the coating may be in particulate form, the food acid or flavor or sensate or sweetener or salt or functional ingredient materials may be present in an amount from about 0.05% w/w to about 20% w/w, preferably from about 5% w/w to about 15% w/w of the coating composition.

In some embodiments, the coating may also include a saccharide or polyol or a combination of saccharide and polyol. Suitable saccharides may include, but are not limited to, mono-saccharides, di-saccharides and poly-saccharides such as but not limited to, sucrose (sugar), dextrose, maltose, dextrin, xylose, ribose, glucose, mannose, galactose, sucromalt, fructose (levulose), invert sugar, corn syrups, maltodextrins, fructo oligo saccharide syrups, partially hydrolyzed starch, corn syrup solids, polydextrose, soluble fibers, insoluble fibers, and mixtures thereof.

Suitable polyols may include, but are not limited to sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysates, maltitol syrups, and mixtures thereof.

Suitable hydrogenated starch hydrolysates include those disclosed in U.S. Pat. No. 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, the coating composition may include encapsulated ingredients as described below.

In embodiments where one of the coating compositions is in crystalline or amorphous form, the coating may be created by any conventional method known in the coating art. Such methods may include, but are not limited to, hard panning, soft panning, enrobing, spray coating, lamination, co-extrusion, multiple-extrusion, drum sanding, thin film depositing, and the like. As with the particulate coating compositions, crystalline or amorphous coating compositions may include sweeteners and food acids and may be created to provide sour taste intensities equivalent to 0.2% w/w solution of citric acid and/or a sour taste intensity of at least 4 on a scale from 0 to 10.

In some embodiments, confectionery and chewing gum products may include an acidic particulate coating. In some embodiments, partially or completely encapsulating an ingredient used in a confectionery composition with an encapsulating material may stabilize the ingredient against moisture absorption and/or moisture migration.

### Larger-Size Particulate Coating Composition

In some embodiments, the coating composition may include one or more candy pieces that are in a larger-size particulate form. The term “larger-size particulate candy pieces” or “larger-size” particulates refers to particulate candy pieces that are larger than typical sanding or dusting particles. Typical “larger-size particles” include nonpareils and flakes. Other typical larger-size particulate candy pieces include such materials as wheat-based fruit flakes, lyophilized fruit flakes, hard candy particles, and combinations thereof In some embodiments, an individual larger-size particle used herein may have a particle size of about 0.1 to about 10 mm in diameter. The individual larger-size particle may be any size desired, and may have a diameter of at least 0.1 mm, at least 0.5 mm, at least 1 mm, at least 2 mm, at least 3 mm, and at least 4 mm.

Larger-size particles may include candy pieces such as nonpareils. As described above, nonpareils are larger sized particles, which may be spherical, amorphous, or any other desired shape. Larger-size particles of the present invention may include other candy forms, including, but not limited to, balls, cubes, sticks, flakes, shapes (such as stars, crescents, and any other desired shape), jimmies, sprinkles, and any other desired particulate candy form. The larger-size particles described herein are typically made from sugar, but may include other components. Typically, larger-size particles of the present invention include sugar in an amount of from about 70% to about 90% by weight of the individual particle. If desired, the individual particle may include sugar in an amount of from about 75% to about 80% by weight of the particle.

The larger-size particles used herein may include any combination of additional other components, including but not limited to acid, dextrose, maltodextrin, malic acid, salt, oil, mannitol, calcium silicate, coloring additives, flavors, and combinations thereof. Acid, such as citric acid, may be present in an amount of from about 1% to about 10% by weight of the individual particle. Dextrose may be present in an amount of from about 1% to about 10% by weight of the individual particle. Maltodextrin may be present in an amount of from about 0.1% to about 8% by weight of the individual particle. Malic acid may be present in an amount of from about 0.1% to about 4% by weight of the individual particle. Salt may be present in an amount of less than about 1% by weight of the individual particle. Oil may be present in an amount of less than about 1% by weight of the individual particle. Mannitol may be present in an amount of less than about 0.5% by weight of the individual particle. Calcium silicate may be present in an amount of less than about 0.1% by weight of the individual particle. If used, colors and/or flavors are preferably present in an amount of less than about 0.5% by weight of the individual particle.

In some embodiments, the coating composition described herein may include a plurality of nonpareils. In other embodiments, the coating composition may include a plurality of flakes. In some embodiments, the coating composition may include a plurality of nonpareils which are combined with one or more other coating compositions, including but not limited to flakes, powders, crystals, or other components typically used in sanding processes. The individual particles and/or flakes in the coating composition may have varying particle sizes and weights. Further, the coating composition may include one or more additional components, such as flavors, colors, sensates, acids, active ingredients, or any other desired components. In some embodiments, for example, the nonpareils may be flavored with chocolate. In addition, the individual particles of the coating composition may be coated with one or more desired components. For example, in one embodiment, the larger-size particles may include silver-colored balls, while in another embodiment, the larger-size particles may include rainbow-colored sticks, and in yet another embodiment, the larger-size particles may include chocolate-flavored flakes. Any combination of shapes, colors, flavors, sensates, actives and other ingredients may be combined to form the larger-size particles of the coating composition as desired.

### Binder Compositions

As explained above, traditional methods of binding coatings, such as steaming, wetting, or electrostatic adhesion methods, may be unsuitable to bind larger-sized particles such as nonpareils and/or flakes. In some embodiments, there may be provided an intermediate binder layer or binder region, which is capable of sufficiently adhering and binding the large-size coating composition to the outer surface of the confectionery or chewing gum compositions. The binder layer (or binder region) includes a suitable binder composition, and may include other additives if desired. In particular when the coating composition includes a plurality of nonpareils or other larger-scale particulate pieces or flakes, the binder solution should be sufficiently viscous to at least partially coat the outer surface of the confectionery or chewing gum piece, but not too viscous so as to slow down or inhibit processing of the coated product. In addition, the binder should have a sufficient amount of a tackifying agent so as to effectively bind and hold the particulate coating composition to the confectionery or chewing gum product over a suitable period of time. Further, the binder should have a viscosity and amount of tackifying agent so as to allow at least 75% of the outer surface of the first region to be covered by larger-sized particles. In some embodiments, at least 80% of the outer surface of the first region is covered by larger-sized particles, and in some embodiments, at least 90% of the outer surface of the first region is covered by larger-sized particles.

At room temperature, the binder layer preferably has a viscosity of at least 2,000 cps, and more preferably between about 2,500 to about 5,000 cps as measured by a Brookfield Rheometer at 87 C. More desirably, the binder layer has a viscosity of between 3,000 and 4,500 cps, and even more desirably has a viscosity of between 3,500 and 4,000 cps. A viscosity in this range will allow for the binder to sufficiently adhere to the outer surface of the confectionery or chewing gum product, but is not too viscous so as to disrupt or impede processing of the coated product.

The binder composition may include a tackifying agent in an amount sufficient to allow for binding of the larger-size particles. In some embodiments, the tackifying agent may be present in an amount of at least 10% by weight of the binder composition. In some embodiments, the tackifying agent is present in an amount of at least 5% by weight of the binder. The tackifying agent may include various components, including glucose, dextrin, and gum arabic. If included as part of the tackifying agent, glucose is preferably present in amounts of from about 5% to about 20% by weight of the total binder composition, and more desirably of from about 10% to about 15% by weight of the total binder composition. Preferably, if used, dextrin is present in amounts of from about 5% to about 30% by weight of the total binder composition, and more desirably of from about 10% to about 20% by weight of the total binder composition. If used, gum arabic is present in amounts of from about 5% to about 10% by weight of the total binder composition, preferably between about 7% to about 9% by weight of the total binder composition, and more desirably is present in an amount of about 8% by weight of the total binder composition.

Having a suitable viscosity and tackifying agent level, the binder layer adequately and effectively binds the larger-size coating composition to the outer surface of the confectionery or chewing gum composition. As will be understood by one of skill in the art, nonpareils or other similar larger-size particulate coating compositions include particles that are larger and heavier than typical coating compositions. As such, a suitable binding layer is especially useful in holding and securing these large-size particles to the outer surface of the product.

The binder composition may include a mixture of any components desired to allow for an effective binding of particles, while still providing the user with a pleasant taste perception. In some embodiments, the binder layer may include sugar. Any desired form of sugar may be used, and in particular the binder layer may include granular sugar. Alternatively, the binder layer may include one or more non-sugar sweeteners. The sugar may be present in any amount, and in preferred embodiments is present in an amount of from about 20% to about 50% by weight of the binder layer, and more desirably is present in an amount of from about 30% to about 45% by weight of the binder layer.

The binder composition preferably includes a sufficient amount of water or other suitable, food grade solvent. In a desired embodiment, the water is present in an amount of from about 20% to about 40% by weight of the binder layer, and more desirably is present in an amount of from about 20% to about 30% by weight of the binder layer.

The binder composition may be formed in any desired method, and may include any or all of the components described above. In one embodiment, the binder layer is formed by mixing together the desired components and heating at a temperature of from about 60° C. to about 100° C. In some embodiments, the binder composition may be heated at temperatures of from 60-65° C., while in other embodiments, the composition may be heated at temperatures of from 70-75° C. Alternatively, the composition may be stored in a heated tank (such as a hot water bath) at temperatures of about 60° C. to about 90° C. In one desired embodiment, the binder is heated at temperatures of about 87° C. In some circumstances, it may be preferable to mix the binder composition at approximately room temperature, or from about 23-25° C. The mixing of the components may last as long as necessary to provide a substantially homogenous binder mixture, and in some instances may be from about 15 to about 30 minutes. The binder composition may then be applied to the confectionery or chewing gum compositions to form a binder layer, as will be described below.

The binder composition may include one or more optional components as desired. For example, the binder composition may include flavors, sweeteners, sensates, acids, colors, or any desired pleasure enhancing components.

### Processes for Preparing Coated Products

In some embodiments, there is provided a method for preparing coated confectionery or chewing gum products, where the coating composition includes a plurality of particulates. For example, the coated confectionery or chewing gum product may include a plurality of larger-size particulates, such as nonpareils, flakes, or other larger coating compositions. In particular, the methods described herein preferably do not subject the confectionery or chewing gum compositions to extreme conditions, such as steam. Further, as explained above, typical adhesion processes, such as steaming, wetting, and electrostatic adhesion processes are insufficient to effectively bind and retain larger-size particles to the surface of the confectionery composition.

The coated confectionery products described herein may be formed via any desired process. In one embodiment, the confectionery products are first formed. As explained above, the confectionery product may include gum base, if desired. Further, the confectionery composition may be a center-filled composition, if desired. The confectionery product may be first formed into individual pieces of confectionery product in any desired shape, or the confectionery product may be extruded or formed into a rope or other shape from which individual pieces of confectionery product are subsequently formed. Desirably, the confectionery product has at least one outer surface which may be coated with the coating compositions described herein.

To effectively bind the larger-size coatings (including coatings that include a plurality of nonpareils) to a confectionery composition, the binder composition should be applied to the outer surface of the confectionery composition. Application of the binder composition forms a second region or layer surrounding the confectionery composition. The binder region may be applied by any means desired, including methods such as spraying, dipping, painting, rolling, extruding, panning, or other similar means. The binder region may be applied to the confectionery composition at any time in the confectionery-forming process. For example, the confectionery composition may be in the form of a rope, and the binder region may be applied to the surface thereof prior to forming individual confectionery pieces. Alternatively, the confectionery composition may be in the form of individual confectionery pieces, which are then at least partially coated with the binder composition. Depending on the viscosity of the binder composition, it may be preferable to apply the binder composition to individual confectionery pieces via panning or spraying.

If desired, the coating composition may be applied to individual confectionery pieces. In one embodiment, the binder solution is first mixed in a regular mixer tank, which is hot water jacketed. The solution may be mixed while heating. Once the solution is sufficiently mixed, it may be transferred to a temperature-controlled holding tank, and subsequently pumped into a reservoir tank. From the reservoir tank, the binder solution may be sprayed via air pressure over the individual confectionery pieces located inside a spraying tumbler. The pieces may be tumbled in the spraying tumbler for any desired length of time, and in preferred embodiments are tumbled for about 15 to about 60 seconds. The sprayed pieces may then be passed to a sanding tumbler where the coating composition is added in counter-flow. The pieces may remain in the sanding tumbler for any desired time, and in preferred embodiments, the pieces are in the sanding tumbler for about 15 to about 60 seconds. Once the sanding process is complete, the pieces may be collected in trays and placed in a temperature and humidity controlled conditioning room for a desired period of time.

The binder composition may be partially applied to the outer surface of the confectionery composition, or it may be applied to the entire outer surface of the confectionery composition to fully surround the confectionery composition. The binder composition may further be applied to only selected areas of the outer surface of the confectionery composition, forming a desired pattern or only covering selected regions.

Once the binder solution has been sufficiently applied to the outer surface or outer surfaces of the confectionery composition, forming a binder layer (or binder region), the coating composition may then be applied to selected regions of the binder layer. If desired, the coating composition may be applied to the entire binder layer or it may be applied to selected areas of the binder layer. The coating composition preferably includes a plurality of larger-size particulate pieces, such as flakes or nonpareils, but may include other smaller-size coating components. The coating composition may be applied to the binder layer by any desired means, including rolling, spraying, panning, tumbling, pressing, or other suitable means by which the coating composition may effectively be applied to the binder layer.

Once the coating composition has been sufficiently applied to the binder layer, the coated confectionery piece is allowed to dry. In a desired embodiment, the coating composition is sufficiently adhered to the binder layer so as to remain attached to the confectionery composition for a desired length of time. Since such coated confectionery pieces typically are packaged and shelved until sold, it is desired that the coating composition remain adhered to the confectionery composition for at least 9 months, and in some embodiments, the coating composition may remain adhered to the confectionery composition for up to 18 months.

In a three-region confectionery piece, the confectionery piece includes a first region including the confectionery base, a second region including the binder composition, and a third region including the particulate coating composition. The confectionery composition may include more regions between any of the first, second, or third regions, and further may include a fourth region at least partially surrounding the third region. The first region (or the region including the confectionery base) of the confectionery composition is present in an amount of from about 10% to about 50% by weight of the coated confectionery piece. If desired, the first region may be present in an amount of from about 20% to about 40% by weight of the coated confectionery piece, or may be present in an amount of about 30% by weight of the coated confectionery piece.

The second region (or the region including the binder composition) of the confectionery composition may be present in any desired amount. It is preferred that the binder composition be present in an amount sufficient to coat the desired areas of the confectionery base region such that the larger-size particles of the coating composition adhere to the confectionery base region. The binder composition region is preferably present in an amount of from about 0.1% to about 20% by weight of the coated confectionery piece. If desired, the binder composition region is present in an amount of about 0.5% to about 5% by weight of the coated confectionery piece. The relative amount of the binder composition region will vary depending on the desired amount of coating per confectionery piece. The third region of the confectionery composition preferably may be present in any desired amounts, and in one preferred embodiment is present in an amount of from about 5% to about 50% by weight of the coated confectionery piece. If desired, the third region may be present in an amount of from about 20% to about 40% by weight of the coated confectionery piece, or may be present in an amount of about 30% by weight of the coated confectionery piece. The third region of an individual confectionery piece is preferably present in an amount of from 1 to about 5 grams, and may be present in an amount of from about 2 to about 4 grams.

It will be understood that, depending on the desired look, taste and feel of the confectionery piece, the confectionery base may be present in larger amounts than the coating composition. Alternatively, the coating composition may be present in larger amounts than the confectionery base.

### Encapsulation

In some embodiments, one or more ingredients may be encapsulated with an encapsulating material. In some embodiments, partially or completely encapsulating an ingredient used in an confectionery composition with an encapsulating material may delay release of the ingredient during consumption of the confectionery composition, thereby delaying when the ingredient becomes available inside the consumer's mouth, throat, and/or stomach, available to react or mix with another ingredient, and/or available to provide some sensory experience and/or functional or therapeutic benefit. This may be particularly true when the ingredient is water soluble or at least partially water soluble.

In some embodiments, partially or completely encapsulating an ingredient used in a confectionery composition with an encapsulating material may stabilize the ingredient against moisture absorption and/or moisture migration.

In some embodiments, a material used to encapsulate an ingredient may include water insoluble polymers, co-polymers, or other materials capable of forming a matrix, solid coating, or film as a protective barrier with or for the ingredient. In some embodiments, the encapsulating material may completely surround, coat, cover, or enclose an ingredient. In other embodiments, the encapsulating material may only partially surround, coat, cover, or enclose an ingredient. Different encapsulating materials may provide different release rates or release profiles or protective barriers for the encapsulated ingredient. In some embodiments, encapsulating material may include one or more of the following: polyvinyl acetate, polyethylene, crosslinked polyvinyl pyrrolidone, polymethylmethacrylate, polylactidacid, polyhydroxyalkanoates, ethylcellulose, polyvinyl acetatephthalate, polyethylene glycol esters, methacrylicacid-co-methylmethacrylate, ethylene-vinylacetate (EVA) copolymer, and the like, and combinations thereof.

In some embodiments, the encapsulating material may include fats, waxes, gelatins, hydrocolloids, or oils and may include one or more of the following: hydrogenated cottonseed oil, hydrogenated palm kernel oil, hydrogenated corn oil, hydrogenated soy bean oil, cocoa butter, hydrogenated vegetable oil, bees wax, and the like, and combinations thereof.

In some embodiments, the encapsulating material may have a melting point from about 45 C to about 70 C. In still other embodiments, the encapsulating material may have a melting point from about 50 C to about 65 C.

In some embodiments, the encapsulating material may be water soluble or water miscible. In such embodiments, the encapsulating material may include, but is not limited to, hydrocolloids such as starch, gum arabic, maltodextrin, dextrins, and the like, and combinations thereof.

In some embodiments, an ingredient may be pre-treated prior to encapsulation with an encapsulating material. For example, an ingredient may be coated with a “coating material” that is not miscible with the ingredient or is at least less miscible with the ingredient relative to the ingredient's miscibility with the encapsulating material.

In some embodiments, the same or different encapsulating material may be used to individually encapsulate different ingredients in the same confectionery composition. In some embodiments, the same or different methods of encapsulation may be used to individually encapsulate different ingredients in the same confectionery composition.

For example, aspartame may be encapsulated by polyvinyl acetate by using an extrusion method. Separately ace-k may be encapsulated by polyvinyl acetate by using an extrusion method. Both encapsulations may be used as ingredients in the same chewing gum or in other confectionery compositions. For addition examples, see U.S. patent application Ser. No. 11/134,367 entitled “A Delivery System for Active Components as Part of an edible Composition” and filed May 23, 2005, the entire contents of which are incorporated herein by reference for all purposes.

In other embodiments, malic acid may be encapsulated by hydrogenated cottonseed oil using a spray chilling method and tartaric acid may be encapsulated by hydrogenated cottonseed oil using a spray chilling method. Both encapsulations may be used in the same confectionery composition or chewing gum.

In some embodiments, different encapsulation materials may be used to individually encapsulate different ingredients used in the same confectionery composition. For example, aspartame may be encapsulated by polyvinyl acetate using an extrusion method. Another encapsulation may include ace-k encapsulated by EVA using an extrusion method. Both encapsulations may be used as ingredients in the same chewing gum or other confectionery compositions. Examples of encapsulated ingredients using different encapsulating materials may be found in U.S. Patent Application Ser. No. 60/655,894 filed Feb. 25, 2005, and entitled “Process for Manufacturing a Delivery System for Active Components as Part of an Edible Composition,” the entire contents of which are incorporated herein by reference for all purposes.

In some embodiments, citric acid may be encapsulated in hydrogenated soy bean oil using a spray chilling method while lactic acid may be encapsulated in gum arabic using a spray drying method. Both encapsulations may then be used in the same confectionery or chewing gum composition.

In some embodiments, different ingredients may be blended and then encapsulated together. For example, aspartame may be mixed with ace-K and then encapsulated together in polyvinyl acetate by an extrusion method. In other embodiments, malic acid may be blended with tartaric acid and then encapsulated together in hydrogenated vegetable oil by a spray chilling method.

### Methods of Encapsulation

There are many ways to encapsulate one or more ingredients with an encapsulating material. For example, in some embodiments, a sigma blade or Banbury™ type mixer may be used. In other embodiments, an extruder or other type of continuous mixer may be used. In some embodiments, spray coating, spray chilling, absorption, adsorption, inclusion complexing (e.g., creating a flavor/cyclodextrin complex, forming a glassy matrix, etc.), coacervation, fluidized bed coating, melt spinning, or other process may be used to encapsulate an ingredient with an encapsulating material.

Examples of encapsulation of ingredients may be found in U.S. Patent Application Ser. No. 60/655,894, filed Feb. 25, 2005, and entitled “Process for Manufacturing a Delivery System for Active Components as Part of an Edible Composition,” the entire contents of which are incorporated herein by reference for all purposes. Other examples of encapsulation of ingredients may be found in U.S. patent application Ser. No. 10/955,255 filed Sep. 30, 2004, and entitled “Encapsulated Compositions and Methods of Preparation,” the entire contents of which are incorporated herein by reference for all purposes. Further examples of encapsulation of ingredients may be found in U.S. patent application Ser. No. 10/955,149 filed Sep. 30, 2004, and entitled “Thermally Stable High Tensile Strength Encapsulation Compositions for Actives,” the entire contents of which are incorporated herein by reference for all purposes. Still further examples of encapsulation of ingredients may be found in U.S. patent application Ser. No. 11/052,672 filed Feb. 7, 2005, and entitled “Stable Tooth Whitening Gum with Reactive Components,” the entire contents of which are incorporated herein by reference for all purposes. Further encapsulation techniques and resulting delivery systems may be found in U.S. Pat. Nos. 6,770,308, 6,759,066, 6,692,778, 6,592,912, 6,586,023, 6,555,145, 6,479,071, 6,472,000, 6,444,241, 6,365,209, 6,174,514, 5,693,334, 4,711,784, 4,816,265, and 4,384,004, the contents of all of which are incorporated herein by reference for all purposes.

In some embodiments, an encapsulation may be sized to a particular size for use as an ingredient in a confectionery composition. For example, in some embodiments, an ingredient may have a particle size of 710, 420, 250, 200, 100, 60, 50 or 25 microns. In some embodiments, the encapsulation may have an average particle size such as, for example, 710, 420, 250, 200, 100, 60, 50 or 25 microns. In some embodiments, the encapsulation has a maximum particle size such as, for example, 710, 420, 250, 200, 100, 60, 50 or 25 microns. The ultimate particle size will depend on the characteristics of the encapsulation and/or the confectionery composition and as such, other sizes are possible in other embodiments. For example, encapsulations and/or confectionery compositions with smooth, creamy textures require smaller particles sizes (below 25 microns) while in other examples, encapsulations and/or confectionery compositions with rough textures require larger particle sizes (above 250 microns). Also, in some embodiments, particles below a certain size (e.g., 25 microns) may be removed. In some embodiments, the particle size distribution may have a narrow range resulting in a sharp distribution. In some embodiments, the particle size distribution may have a wide range resulting in a smooth distribution.

### Ingredients

The various components of the coated confectionery compositions, including the first confectionery region, chewing gum region, binder region, and/or the coating region may include one or more ingredients as desired. For example, any or all of the above components may include one or more sweeteners, flavors, potentiators, sensates, functional ingredients, acids, or combinations thereof. Suitable sweeteners, flavors, potentiators, sensates, functional ingredients, and acids include those described in U.S. patent application Ser. Nos. 11/829,232, filed Jul. 27, 2007, and 12/100,046, filed Apr. 9, 2008, the entire contents of which are incorporated by reference herein.

### Confectionery Compositions

In some embodiments, the confectionery compositions may include a confectionery region. The confectionery region may include chewable gummy candy or “gummi” confections. Also included in those chewable forms are soft candies such as, but not limited to, gum drops, licorice, fruit snacks, starch based jellies, gelatin based jellies, pectin based jellies, carageenan based jellies, agar based jellies, konjac based jellies, chewy candy, starch candy, nougat, toffee, taffy, marshmallow, fondant, fudge, chocolate, compound coating, carob coating, caramel, compressed tablets, candy floss (also known as cotton candy), marzipan, hard boiled candy, nut brittles, pastilles, pralines, dragees, lozenges, sugared nuts, comfits, aniseed balls, nougatine, and jelly beans. The base of the confectionery may be a sugar/glucose syrup combination or a polyol/polyol syrup combination and a gelatinizing agent, the latter of which may be gelatin, agar, gum arabic, maltodextrin, pectin, modified starches or combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

### Chewing Gum Compositions

In some embodiments, the first region of the confectionery composition described herien may include a chewing gum composition. Chewing gum compositions may be provided in a variety of different forms, such as, for example, slab, pellet, sticks, balls, cubes, center-fill gums, candy gum, multi-region gum, multi-layer gum, bubble gum, deposited gums and compressed gums. The chewing gum compositions also may include at least one flavor and a variety of optional additives. In some embodiments, the chewing gum compositions described herein may be formed in a rope or sheet form and then processed into individual forms as described above.

The chewing gum composition also may include a gum base. The gum base may include any component known in the chewing gum art. Such components may be water soluble, water-insoluble or a combination thereof. For example, the gum base may include elastomers, bulking agents, waxes, elastomer solvents, emulsifiers, plasticizers, fillers and mixtures thereof.

### Intrinsic Moisture Barrier Layer

In some embodiments, an intrinsic moisture resistant barrier layer is provided which may prevent moisture migration between the confectionery or chewing gum base and the coating. The intrinsic moisture resistant barrier layer may include a crystalline form of a saccharide or polyol. In some embodiments, the intrinsic moisture resistant barrier layer is formed when saccharides or polyols in the confectionery base crystallize at the surface of the confectionery or chewing gum base.

In some embodiments, to aid the process of crystallization, the amount of crystallizing saccharide or polyol in the confectionery base may be increased as compared to confectionery or chewing gum base compositions without intrinsic moisture resistant barrier layers.

For example, the amount of sucrose in a confectionery or chewing gum base may be increased from 70% glucose to 30% sucrose to 50% glucose to 50% sucrose. This increase in the relative amount of sucrose may aid in the formation of a crystalline sucrose intrinsic moisture resistant barrier layer.

In other embodiments, the process of crystallization may be aided by the application of seed crystals to the surface of the confectionery or chewing gum base by nucleating the saccharide or polyol contained in the confectionery or chewing gum base.

In some embodiments, seed crystals may be included in a molding composition that comes in contact with the confectionery base. Molding composition may include starch. The process of molding may include drying the starch containing molding composition to a desired moisture level and placing it in trays. Impressions may then be created in the starch trays after which the confectionery or chewing gum base may be filled into the impressions. After allowing the confectionery or chewing gum base to reach a desired firmness, the confectionery or chewing gum base is separated from the molding composition and further processed, packaged, etc.

In another example, seed crystals of erythritol may be included in the starch used for starch molding an erythritol-containing confectionery or chewing gum base. These seed crystals may aid in the formation of a crystalline erythritol intrinsic moisture resistant barrier layer.

### Center-Fill Composition

In some embodiments, there may be provided a center-fill composition which is included in a center-fill chewing gum or confectionery composition. The center-fill chewing gum composition may include a center-fill composition and a chewing gum region. The center-fill confectionery composition may include a center-fill composition and a confectionery region. The center-fill composition may include any conventional filling or combination of filling materials. The center-fill may be sugar or sugar-free and it may contain fat or be fat-free. Additionally, the center-fill may contain vegetable-based, dairy-based or fruit-based materials such as, but not limited to, fruit juices, fruit concentrates, fruit purees, dried fruit materials, and the like. Further, in some embodiments, the center-fill component may include one or more sweeteners such as those discussed above. The center-fill may also include one or more hydrocolloid materials.

In some embodiments, hydrocolloid materials may include naturally occurring materials such as plant exudates, seed gums, and seaweed extracts or they may be chemically modified materials such as cellulose, starch, or natural gum derivatives. In some embodiments, hydrocolloid materials may include starches, flour, pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations may be included. In some embodiments, modified celluloses may be included such as microcrystalline cellulose, carboxymethlcellulose (CMC), methylcellulose (MC), hydroxypropylmethylcellulose (HPCM), and hydroxypropylcellulose (MPC), and combinations thereof. In some embodiments, it is desirable to include hydrocolloid materials that increase the viscosity of the center-fill composition.

In some embodiments, the texture of the center-fill is the same as the texture of the chewing gum or confectionery composition. In other embodiments, the texture of the center-fill is different than the texture of the chewing gum or confectionery composition. In other embodiments, the center-fill may include one or more large-size particulates or flakes.

In some embodiments, the appearance of the center-fill is the same as the appearance of the chewing gum or confectionery composition. In other embodiments, the appearance of the center-fill is different than the appearance of the chewing gum or confectionery composition.

The center-fill chewing gum or confectionery composition may also include one or more food acids as discussed above and such as acetic acid, adipic acid, ascorbic acid, butyric acid, citric acid, formic acid, fumaric acid, glyconic acid, lactic acid, phosphoric acid, malic acid, oxalic acid, succinic acid, tartaric acid, citrates, and combinations thereof. These food acids or blends thereof may be included in amounts from about 0.5% w/w to about 5.0% w/w of the center-fill composition. In some embodiments, buffering agents such as citrates may be included.

In some embodiments, the center-fill chewing gum or confectionery composition may include buffering agents, coloring, flavoring, and preservatives.

Further, in some embodiments, the center-fill composition may include functional ingredients as discussed above and such as, but not limited to, medicaments, nutrients such as vitamins and minerals and the like, nutraceuticals such as phytochemicals and the like, breath freshening agents, oral care agents, probiotic materials, prebiotic materials, taste and/or flavor potentiators, and throat care agents.

In some embodiments, the center-fill composition may include flavors and/or sensates as discussed above.

In some embodiments, the center-fill composition may be included in the coated center-filled chewing gum or confectionery composition in amounts from about 1 percent by weight of the total composition to about 25 percent by weight of the total composition.

### Gummy Candy Shell Composition

Some embodiments may include a gummy candy shell composition, which at least partially covers the outer surface of the first region. In such embodiments, the binder composition may be applied to the outer surface of the gummy candy shell composition. The gummy candy shell composition may include any conventional gummy candy material such as, but not limited to, sweeteners, hydrocolloids, and food acids. Suitable examples of these materials are described above and may be used with equal applicability here. For the hydrocolloid materials, in some embodiments, a desired texture is created by using hydrocolloids that form chewable gels when combined with the other ingredients in the gummy candy shell composition.

In some embodiments, pectin and gelatin may be used together in a gummy candy shell composition as described in U.S. application Ser. No. 10/977,585, filed Oct. 28, 2004 and incorporated herein for all purposes. This combination of hydrocolloids may create a gummy candy shell that sets up quickly and provides adequate shell strength and desirable texture.

In some embodiments, the gummy candy shell composition may contain sweeteners in amounts from about 35% w/w to about 75 w/w of the gummy candy shell composition. In some embodiments, the gummy candy shell composition may contain from about 0.01% w/w to about 15 w/w, and preferably from about 1% to about 8% w/w of hydrocolloids. In some embodiments, the gummy candy shell composition may contain from about 0.3% to about 3%, and preferably from about 0.5% w/w/ and about 2.0% w/w food acids.

As with the center-fill composition, in some embodiments, the gummy candy shell composition can also include buffering agents, coloring, flavoring, and preservatives.

Further, in some embodiments, the gummy candy shell composition can include functional ingredients such as, but not limited to, medicaments, nutrients such as vitamins and minerals and the like, nutraceuticals such as phytochemicals and the like, breath freshening agents, oral care agents, probiotic materials, prebiotic materials, taste and/or flavor potentiators, and throat care agents.

In some embodiments, the gummy candy shell composition can include flavors and/or sensates as discussed above.

In some embodiments, the gummy candy shell composition can be included in the coated center-filled gummy candy composition in amounts from about 70 percent by weight of the total composition to about 95 percent by weight of the total composition.

### Processing of Center-Fill Chewing Gums

In some embodiments, center-fill chewing gum embodiments may include a center-fill region, which may be a liquid or powder or other solid, or gas, and a gum region. Some embodiments also may include an outer gum coating or shell, which typically provides a crunchiness or texture difference as compared to un-coated gum to the piece when initially chewed. The outer coating or shell may at least partially surround the gum region. Center-fill chewing gums and methods of preparing same are more fully described in assignee's co-pending U.S. patent application Ser. No. 10/925,822, filed on Aug. 24, 2004 and assignee's co-pending U.S. patent application Ser. No. 11/210,954, filed on Aug. 24, 2005, both entitled “Liquid-Filled Chewing Gum Composition,” the contents both of which are incorporated herein by reference.

In embodiments where the confectionery composition includes an outer gum coating or shell, the binder composition may

The center-fill gum composition and other compositions described herein may be formed by any technique known in the art which includes the method described by U.S. Pat. No. 6,280,780 to Degady et al. (“Degady”) which is herein incorporated by reference in its entirety. Degady describes an apparatus and method for forming center-filled gum pellets. The method includes first extruding a liquid-filled rope of a chewing gum layer and passing the rope through a sizing mechanism including a series of pairs of pulley-shaped roller members. The roller members “size” the rope or strand of gum material such that it leaves the series of rollers with the desired size and shape for entering a tablet-forming mechanism.

The rope is then led into a tablet-forming mechanism including a pair of rotating chain die members which are endless chain mechanisms and both rotate at the same speed by a motor and gear mechanism. Each of the chain mechanisms include a plurality of open curved die groove members which mate and form die cavities in which the pieces of gum material (pellets or tablets) are formed. While Degady is limited to the formation of pellet or tablet shaped pieces, the gum pieces may be of other shapes as described above. The shape of the die groove members may be altered to provide any desired shape.

The gum may optionally be passed through a cooling tunnel either before entering the tablet-forming mechanism, after exiting the tablet-forming mechanism or both. Cooling of the rope prior to entering the tablet-forming mechanism may be beneficial to prevent rebound of the individual pieces and thus may provide an increase in productivity.

The cooled pieces of gum material are then fed into a storage container for conditioning and further processing. At this point, the cooled pieces of gum material could also be fed directly into a coating tunnel mechanism, such as a rotating tunnel mechanism.

Whether the pieces of formed gum material are first stored, transported in a storage container, or fed directly into a coating tunnel or mechanism, the individual pieces of gum material may subsequently be subjected to a conventional sugar or sugarless coating process in order to form a hard exterior shell on the liquid-filled gum material. A variety of coating processes or mechanisms of this type are known. In some embodiments, the coating is applied in numerous thin layers of material in order to form an appropriate uniform coated and finished quality surface on the gum products. The hard coating material, which may include sugar, maltitol, sorbitol or any other polyol, including those described herein, and optionally flavoring, is sprayed onto the pellets of gum material as they pass through a coating mechanism or a coating tunnel and are tumbled and rotated therein. In addition, conditioned air is circulated or forced into the coating tunnel or mechanism in order to dry each of the successive coating layers on the formed products. In some embodiments, the coating, or outermost region, can be formed by lamination, dual or multiple extrusion, or any other process that creates an outermost region.

The coating composition may range from about 2% to about 80%, more specifically, about 20% to about 40% by weight of an individual gum or confectionery piece which includes a center-fill, a gum or confectionery region and a coating; even more specifically, from 25% to 35% and still more specifically around 30%. The coating may include sugar or polyol such as maltitol as the primary component, but may also include flavors, colors, etc. as described below in the discussion of the gum region. The coating or outermost region may be crystalline or amorphous.

In some embodiments, chewing gum embodiments may include an outer gum coating or shell, which typically provides a crunchiness or texture difference as compared to un-coated gum to the piece when initially chewed. The outer coating or shell may at least partially surround the gum region.

Chewing gum can be created using any conventional method known to those of ordinary skill in the art. In some embodiments, gum base is warmed or melted in a gum mixer to which bulk sweeteners and sweetener or polyol syrups are added and mixed until homogeneous. Flavors (which can include sensates dissolved or suspended therein), food acids, and any other ingredients are then added with mixing. Once the gum is mixed as desired, the gum mass is further processed into individual pieces. In some embodiments, a rope of chewing gum is extruded or formed and is then led into a tablet-forming mechanism including a pair of rotating chain die members which are endless chain mechanisms and both rotate at the same speed by a motor and gear mechanism. Each of the chain mechanisms include a plurality of open curved die groove members which mate and form die cavities in which the pieces of gum material (pellets or tablets) are formed. The gum pieces may be of other shapes as described above. The shape of the die groove members may be altered to provide any desired shape.

The gum may optionally be passed through a cooling tunnel either before entering the tablet-forming mechanism, after exiting the tablet-forming mechanism or both. Cooling of the rope prior to entering the tablet-forming mechanism may be beneficial to prevent rebound of the individual pieces and thus may provide an increase in productivity.

The cooled pieces of gum material are then fed into a storage container for conditioning and further processing. At this point, the cooled pieces of gum material could also be fed directly into a coating tunnel mechanism, such as a rotating tunnel mechanism.

In some embodiments, the chewing gum pieces are formed by rolling the chewing gum into sheets and cutting the pieces into various shapes such as cubes, rectangles, slabs, sticks, etc.

Whether the pieces of formed gum material are first stored, transported in a storage container, or fed directly into a coating tunnel or mechanism, the individual pieces of gum material may subsequently be subjected to a conventional sugar or sugarless coating process in order to form a hard exterior shell on the liquid-filled gum material. A variety of coating processes or mechanisms of this type are known. In some embodiments, the coating is applied in numerous thin layers of material in order to form an appropriate uniform coated and finished quality surface on the gum products. The hard coating material, which may include sugar, maltitol, sorbitol or any other polyol, including those described herein, and optionally flavoring, is sprayed onto the pellets of gum material as they pass through a coating mechanism or a coating tunnel and are tumbled and rotated therein. In addition, conditioned air is circulated or forced into the coating tunnel or mechanism in order to dry each of the successive coating layers on the formed products. In some embodiments, the coating, or outermost region, can be formed by lamination, dual or multiple extrusion, or any other process that creates an outermost region.

The coating composition may range from about 2% to about 80%, more specifically, about 5% to 15% by weight of an individual gum piece. The coating may include sugar or polyol such as maltitol as the primary component, but may also include flavors, colors, etc. as described below in the discussion of the gum region. The coating or outermost region may be crystalline or amorphous.

Coated center-filled gummy candy compositions can be created using any conventional method known to those of ordinary skill in the art. The center-fill composition can be prepared by mixing the individual ingredients together with conventional mixing equipment such as batch cookers, scraped surface mixers, and the like. In some embodiments, hydrocolloid materials may be hydrated prior to addition to the center-fill composition. In other embodiments, the mixed center-fill composition is heat treated to adjust the solids content to a desired level. In some embodiments, the mixture is heated to a final temperature of 215 F to 235 F.

In some embodiments, the tackiness of a confectionery surface to which a binder composition has been applied may be manipulated by varying the drying conditions. Manipulating the tackiness of a confectionery surface affects the adherence of various particle size distributions of the particulate coating being adhered to the surface of the confectionery composition. In some embodiments, longer drying times increase the tackiness of the confectionery surface. When the confectionery surface is tackier, larger particles will adhere. In some embodiments, drying time of 30 to 60 seconds may aid in the adherence of particles with larger-size particles, including those particles up to 5 mm in diameter.

In some embodiments, a particulate coating composition may include a range of particle sizes. In addition to the larger-size particles (such as nonpareils), the particulate coating may include smaller-sized particles. For example, a particulate coating composition including particles having particle sizes of about 10-100 microns in diameter, 100-200 microns in diameter and about 200 microns and above could be adhered to a confectionery surface through application of the binder composition described herein.

In some embodiments, moisture sensitive ingredients such as carbonated or gasified candy can be included in the particulate coating composition.

### EXAMPLES

### Example 1

### Viscosity of Sugar Binder Compositions

Various binder compositions were prepared using different levels of various components. The compositions are set forth in Table 1 below:

| | A | B | C | D | E | F | G |
|---|---|---|---|---|---|---|---|
| Sugar | 55% | 52.5% | 55.08% | 37% | 43.67% | 65.66% | 69.83% |
| Water | 25% | 30% | 24.12% | 25% | 28.33% | 23.34% | 24.17% |
| Glucose | 0% | 0% | 5.8% | 10% | 10% | 10% | 5% |
| Dextrin | 20% | 17.5% | 15% | 20% | 10% | 0% | 0% |
| CMC | 0% | 0% | 0% | 0% | 0% | 1% | 1% |
| Gum arabic | 0% | 0% | 0% | 8% | 8% | 0% | 0% |
| Viscosity | 2627 | 2705 | 2455 | 4569 | 3567 | 893 | 793 |
| (cps) at | | | | | | | |
| 87 C. | | | | | | | |

Viscosity was measured using a Brookfield Rheometer with a circulating bath, spindles size was sample thickness dependent. Viscosity was determined within a RPM range of 5 to 250 at 87° C.

Each of the above binder compositions were prepared and added to the surface of confectionery pieces. Coating compositions including a plurality of nonpareils were attempted to be adhered to the individually binder-coated pieces. It was determined that only compositions D and E were successful in sufficiently binding the coating compositions. Compositions A, B, and C were sufficient to bind sugar sanding compositions, but did not have the required adhesiveness and viscosity levels to bind a plurality of nonpareils. Similarly, compositions F and G were unsuccessful in binding compositions including nonpareils.

Based on the experiments conducted, it was determined that binder solutions D and E were preferred for binding a coating composition including a plurality of nonpareils.

### Example 2

### Sugarless Binder Compositions

Various binder compositions are prepared using different levels of various components. The compositions are set forth in Table 2 below:

| | A | B | C | D | E | F | G |
|---|---|---|---|---|---|---|---|
| Maltitol | 55% | | | | | 43.67% | 55.08% |
| Hydrogenated | | 55% | | | 43.67% | | |
| Isomaltulose | | | | | | | |
| Sorbitol | | | | 37% | | | |
| Erythritol | | | 55.08% | | | | |
| Water | 25% | 25% | 24.12% | 25% | 28.33% | 27.33% | 23.12% |
| Sorbitol | | | | 10% | 10% | | |
| syrup | | | | | | | |
| Hydrogenated | 0% | 0% | 5.8% | | | 10% | 5.8% |
| starch | | | | | | | |
| hydrolysate | | | | | | | |
| syrup | | | | | | | |
| Dextrin | 20% | 17.5% | 15% | 20% | 10% | 18% | 15% |
| CMC | 0% | 0% | 0% | 0% | 0% | 1% | 1% |
| Gum arabic | 0% | 0% | 0% | 8% | 8% | 0% | 0% |

Each of the above binder compositions are prepared and added to the surface of confectionery pieces.

### Example 3

### Comparative Sugarless Binder Compositions

Various sugarless binder compositions were prepared using different levels of components. The compositions are set forth in Table 3 below:

| | H | J | K | L |
|---|---|---|---|---|
| Maltitol | 75% | 75% | 75% | 75% |
| Water | 23% | 21% | 19% | 17% |
| Gum arabic | 2% | 4% | 6% | 10% |

Each of the above binder compositions were prepared and attempted to be added to the surface of confectionery pieces. Composition H provided a very low sticky effect, producing a solution that did not effectively stick to the surface of the confectionery pieces. Composition H was unsuitable for binding larger-size particles to the surface of the piece. Composition J formed a slightly more sticky solution than Composition H. Composition J was able to stick slightly to the surface of the confectionery piece, but was easily peeled off of the surface. This binder was unsuitable for binding larger-size particles to the surface. Composition K formed a solution that was able to stick to the surface of the confectionery piece, but was less desirable for binding larger-size particles. Composition L did not form a suitable solution, as it recrystallized and contained solid particles in a suspension that did not dissolve. It was determined that each of compositions H, J, K and L were undesirable for the purpose of binding larger-size particles.

1. A confectionery composition comprising:
a. a first region having at least one outer surface;
b. a second region at least partially surrounding said outer surface, wherein said second region comprises a binder wherein said binder comprises a tackifying agent in an amount of at least 10% by weight of said binder; and
c. a third region comprising a plurality of larger-size particulate candy pieces bound to said second region.

2. The composition of claim 1, wherein said larger-size particulate candy pieces are selected from the group consisting of nonpareils, wheat-based fruit flakes, lyophilized fruit flakes, hard candy particles, and combinations thereof.

3. The composition of claim 1, wherein said tackifying agent is selected from the group consisting of dextrins, glucose, gum arabic, and combinations thereof.

4. The composition of claim 1, wherein said second region has a viscosity of at least 2,000 cps at 87 C.

5. The composition of claim 1, wherein said larger-size particulate candy pieces cover at least 75% of said outer surface of said first region.

6. The composition of claim 1, wherein said second region has a viscosity of between about 3,000 and 4,500 cps at 87 C.

7. The composition of claim 1, wherein said third region comprises about 10% to about 50% by weight of the confectionery composition.

8. The composition of claim 1, wherein said third region comprises a weight of about 1 to about 5 grams.

9. The composition of claim 1, wherein each of individual larger-size particulate candy pieces has a particle size of about 0.1 to about 5 mm in diameter.

10. The composition of claim 1, wherein said first region comprises a gum base.

11. The composition of claim 1, wherein said second region further comprises a flavor.

12. The composition of claim 1, wherein said second region further comprises a color.

13. The composition of claim 1, wherein said binder comprises sugar, water, glucose, dextrin, and gum arabic.

14. The composition of claim 2, wherein said nonpareils comprise sucrose and glucose.

15. A confectionery composition comprising:
a. a first region having at least one outer surface;
b. a second region at least partially surrounding said outer surface, wherein said second region has a viscosity of at least 2,000 cps at 87 C; and
c. a third region comprising a plurality of larger-size particulate candy pieces bound to said second region.

16. The composition of claim 15, wherein said larger-size particulate candy pieces are selected from the group consisting of nonpareils, wheat-based fruit flakes, lyophilized fruit flakes, hard candy particles, and combinations thereof.

17. The composition of claim 15, wherein said tackifying agent is selected from the group consisting of dextrins, glucose, gum arabic, and combinations thereof.

18. The composition of claim 15, wherein said larger-size particulate candy pieces cover at least 75% of said outer surface of said first region.

19. The composition of claim 15, wherein said second region has a viscosity of between about 3,000 and 4,500 cps at 87 C.

20. The composition of claim 15, wherein said third region comprises about 10% to about 50% by weight of the confectionery composition.

21. The composition of claim 15, wherein said third region comprises a weight of about 1 to about 5 grams.

22. The composition of claim 15, wherein each of individual larger-size particulate candy pieces has a particle size of about 0.1 to about 5 mm in diameter.

23. The composition of claim 15, wherein said first region comprises a gum base.

24. The composition of claim 15, wherein said second region further comprises a flavor.

25. The composition of claim 15, wherein said second region further comprises a color.

26. The composition of claim 15, wherein said binder comprises sugar, water, glucose, dextrin, and gum Arabic.

27. The composition of claim 16, wherein said nonpareils comprise sucrose and glucose.

28. A process for forming a coated confectionery composition comprising the steps of:
a. forming a confectionery region having at least one outer surface;
b. applying a binder to said outer surface, wherein said binder comprises a tackifying agent in an amount of at least 10% by weight of said binder; and
c. applying a plurality of larger-size particulate candy pieces to bind to said binder.

29.-42. (canceled)

43. A confectionery composition comprising:
a. a first region having at least one outer surface;
b. a second region at least partially surrounding said outer surface, said second region comprising a binder solution comprising: i. about 30% to about 50% sugar; ii. about 20% to about 40% water; iii. about 5% to about 15% glucose; iv. about 5% to about 30% dextrin; and v. about 8% gum arabic; and
c. a third region comprising a plurality of nonpareils bound to said second region;
wherein said second region has a sufficient adhesion value to bind said nonpareils to said confectionery region.
